(19) United States
(12) Patent Application Publication
(10) Pub. No.: US 2025/0014569 A1
(43) Pub. Date: Jan. 9, 2025

(54) STEREOPHONIC AUDIO GENERATION

(71) Applicant: International Business Machines Corporation, Armonk, NY (US)

(72) Inventors: Yasmin Aumeeruddy, South Woodford (GB); Thomas Jeffrey Solomon, Fordingbridge (GB)

(21) Appl. No.: 18/446,509

(22) Filed: Aug. 9, 2023

(30) Foreign Application Priority Data
Jul. 4, 2023 (GB) 2310231.2

(51) Int. Cl. G10L 15/00; G06V 40/10; G10L 15/02; G10L 21/055; G10L 25/27; G10L 25/54

(52) U.S. Cl. CPC G10L 15/005; G06V 40/10; G10L 15/02; G10L 21/055; G10L 25/27; G10L 25/54

(57) ABSTRACT

Stereophonic audio generation for a video having a monophonic audio track includes using a feature recognition algorithm to identify visual features of interest in the video. For each visual feature of interest, a spatial location of the visual feature is determined in the video. A sound of interest is identified in the monophonic audio track and an audio fingerprint is determined for the sound of interest. The video is analyzed based on the sound of interest and the audio fingerprint to identify if the sound of interest is linked to any of the visual features. Responsive to identifying the sound of interest is linked to a visual feature of interest, the sound of interest is associated with the spatial location of the visual feature in the video. The stereo location of the sound of interest is determined within the stereoscopic audio for the video based on the associated spatial location.

### BACKGROUND

The present invention generally relates to the field of stereophonic audio, and more particularly, to stereophonic audio generation for videos.

Video creation and streaming is commonplace today, with dedicated platforms to allow individuals or groups to broadcast both audio and video content for others to watch (sometimes in real-time). Video creation and streaming is typically performed using video-sharing/provision platforms. Often, such video content is recorded and distributed with little to no sound engineering or production.

For example, recording and streaming video content is often performed using a portable video capture device (such as a mobile phone) that employs a single microphone, thus producing a video with monophonic audio. When playing back or sharing such video content with monophonic audio, a user would not be able to experience the benefits associated with stereophonic audio.

Using multiple audio capture devices (e.g., microphones) during the recording of video content would enable the creation of videos with stereophonic audio. However, multiple audio capture devices may not be available and/or be practical to employ. Particularly, for a video creator wishing to use a small, portable, and convenient video capture equipment (such as a mobile phone, tablet computer or handheld camera).

### SUMMARY

The present invention provides one or more concepts for generating stereophonic audio for a video having a monophonic audio track. Such concepts may be computer-implemented. That is, such methods may be implemented in a computer infrastructure having computer executable code tangibly embodied on a computer readable storage medium having programming instructions configured to perform a proposed method. The present invention further provides a computer program product including computer program code for implementing the proposed concepts when executed on a processor. The present invention yet further provides a system for generating stereophonic audio for a video having a monophonic audio track.

According to an aspect of the present invention there is provided a computer-implemented method for generating stereophonic audio for a video having a monophonic audio track. The method includes processing the video with a feature recognition algorithm to identify one or more visual features of interest. The method also includes, for each of the one or more visual features of interest, determining the spatial location of the visual feature of interest in the video. The method further includes identifying, in the monophonic audio track of the video, a sound of interest; determining an audio fingerprint for the sound of interest. The method yet further includes analyzing the video based on the sound of interest and its determined audio fingerprint to identify if the sound of interest is linked to any of the one or more visual features of interest; and, responsive to identifying the sound of interest is linked to a visual feature of interest, associating the sound of interest with the determined spatial location of the visual feature of interest in the video. The method yet further includes defining the stereo location of the sound of interest within stereoscopic audio for the video based on its associated spatial location in the video.

Proposed embodiments may thus provide one or more concepts for automatically generating a stereophonic audio signal/track for a video captured using a video capture device having a single microphone. In particular, embodiments may provide a mechanism for generating stereophonic audio for a video from a monophonic audio signal/track of the video.

By way of example, proposed is a concept for automatically generating stereophonic audio for a video captured using a video capture device having a single microphone (i.e., a video with monophonic audio). In particular, embodiments may provide a mechanism for generating stereophonic audio for a video from a monophonic audio signal/track of the video.

Generating stereoscopic audio typically requires the use of multiple microphones to capture sound from different directions and create a sense of spatialization. However, with the techniques proposed herein, a stereo effect may be simulated from monophonic audio of a video. By employing feature recognition techniques in the video, and linking a sound of interest in the monophonic audio to a feature identified in the video, embodiments may associate the sound of interest to the identified feature and thus its location in the video. In this way, different sounds of interest in the monophonic audio may be assigned to different stereo locations/positions, thus enabling panning on the sounds of interest to their assigned stereo locations/positions in a stereophonic soundscape.

Proposed embodiments may therefore provide hardware-based and/or software-based solutions that can process monophonic audio recordings and convert them into stereophonic audio (i.e., stereophonic soundscapes). Embodiments may thus enhance a listening experience and create a more immersive soundstage. Such proposed techniques may leverage digital signal processing algorithms to simulate the cues necessary for a stereo effect.

In addition, embodiments of the present invention provide concepts for a non-transitory computer readable medium including code stored thereon that, when executed, performs a method for generating stereophonic audio for a video having a monophonic audio track, the method including processing the video with a feature recognition algorithm to identify one or more visual features of interest; for each of the one or more visual features of interest, determining the spatial location of the visual feature of interest in the video; identifying, in the mono audio track of the video, a sound of interest; determining an audio fingerprint for the sound of interest; analyzing the video based on the sound of interest and its determined audio fingerprint to identify if the sound of interest is linked to any of the one or more visual features of interest; responsive to identifying the sound of interest is linked to a visual feature of interest, associating the sound of interest with the determined spatial location of the visual feature of interest in the video; and defining the stereo location of the sound of interest within stereoscopic audio for the video based on its associated spatial location in the video.

Embodiments may be employed in combination with conventional/existing video capture equipment and/or applications, such as mobile phones and tablet computers (and/or their software applications) for example. In this way, embodiments may integrate into legacy systems to improve and/or extend their functionality and capabilities. An improved video capture/creation device/application may therefore be provided by proposed embodiments.

According to another aspect, there is provided a system including one or more processors; and a memory including code stored thereon that, when executed, performs a method for generating stereophonic audio for a video having a monophonic audio track, the method including processing the video with a feature recognition algorithm to identify one or more visual features of interest; for each of the one or more visual features of interest, determining the spatial location of the visual feature of interest in the video; identifying, in the mono audio track of the video, a sound of interest; determining an audio fingerprint for the sound of interest; analyzing the video based on the sound of interest and its determined audio fingerprint to identify if the sound of interest is linked to any of the one or more visual features of interest; responsive to identifying the sound of interest is linked to a visual feature of interest, associating the sound of interest with the determined spatial location of the visual feature of interest in the video; and defining the stereo location of the sound of interest within stereoscopic audio for the video based on its associated spatial location in the video.

Thus, there may be proposed concepts for automatically generating stereophonic audio data based on data from a single audio capture device (e.g., single microphone), with the concepts providing one or more approaches to simulating a stereo effect using a single microphone. These approaches may leverage video data to determine a location/position of a detected sound, and therefore provide more accurate audio for achieving desired outcomes.

### BRIEF DESCRIPTION OF THE DRAWINGS

The following detailed description, given by way of example and not intended to limit the invention solely thereto, will best be appreciated in conjunction with the accompanying drawings, in which:

FIG. 1 depicts a computing node, according to an embodiment of the present invention;

FIG. 2 depicts an illustrative computing environment, according to embodiments of the present invention;

FIG. 3 is a simplified flow diagram of a method for generating stereophonic audio for a video having a monophonic audio track, according to an embodiment of the present invention;

FIG. 4 depicts a process for generating stereophonic audio for a video having a monophonic audio track, according to a proposed embodiment of the present invention; and

FIG. 5 is a simplified block diagram of a system for generating stereophonic audio for a video having a monophonic audio track, according to an embodiment of the present invention.

The drawings are not necessarily to scale. The drawings are merely schematic representations, not intended to portray specific parameters of the invention. The drawings are intended to depict only typical embodiments of the invention. In the drawings, like numbering represents like elements.

### DETAILED DESCRIPTION

In the context of the present application, where embodiments of the present invention constitute a method, it should be understood that such a method is a process for execution by a computer, i.e., is a computer-implementable method. The various steps of the method therefore reflect various parts of a computer program, e.g., various parts of one or more algorithms.

Also, in the context of the present application, a system may be a single device or a collection of distributed devices that are adapted to execute one or more embodiments of the methods of the present invention. For instance, a system may be a personal computer (PC), a portable computing device (such as a tablet computer, laptop, smartphone, etc.), a set-top box, a server, or a collection of PCs and/or servers connected via a network such as a local area network, the Internet and so on to cooperatively execute at least one embodiment of the methods of the present invention.

The technical character of the present invention generally relates to the field of audio processing, and more particularly, to stereophonic audio generation for video. More specifically, embodiments of the present invention provide concepts for generating stereophonic audio for a video having a monophonic audio track.

There is provided a method for generating stereophonic audio for a video having a monophonic audio track. The method includes processing the video with a feature recognition algorithm to identify one or more visual features of interest. The method also includes, for each of the one or more visual features of interest, determining the spatial location of the visual feature of interest in the video. The method further includes identifying, in the monophonic audio track of the video, a sound of interest; determining an audio fingerprint for the sound of interest. The method yet further includes analyzing the video based on the sound of interest and its determined audio fingerprint to identify if the sound of interest is linked to any of the one or more visual features of interest; and, responsive to identifying the sound of interest is linked to a visual feature of interest, associating the sound of interest with the determined spatial location of the visual feature of interest in the video. The method yet further includes defining the stereo location of the sound of interest within stereoscopic audio for the video based on its associated spatial location in the video.

Accordingly, proposed is a concept for automatically generating stereophonic audio for a video captured using a video capture device having a single microphone. In particular, embodiments may provide a mechanism for generating stereophonic audio for a video from a monophonic audio signal/track of the video. However, although described in relation to video capture devices having a single microphone, embodiments may be applied to other monophonic video equipment/applications.

For the avoidance of doubt, reference to monophonic audio should be taken to refer to ‘mono’ audio or monaural audio having just one audio signal that uses a single audio channel for playback or recording. Conversely, reference to stereophonic audio should be taken to refer to ‘stereo’ having two audio signals designed for two separate audio channels (which creates a perception of space). Stereo location may thus describe a perceived location (i.e., direction and position) of audio/sound with respect to a reference capture location/position (e.g., location of audio capture device, corresponding to a listener location). Stereo audio is the default setup typically used by headphones.

Generating stereoscopic audio typically requires the use of multiple microphones to capture sound from different directions and create a sense of spatialization. However, with the audio processing techniques proposed herein, it is possible to simulate a stereo effect using monophonic audio (e.g., audio data for a video captured by a single microphone). By employing feature recognition techniques in the video, and linking a sound of interest in the monophonic audio to a feature identified in the video, embodiments may associate the sound of interest to the feature and thus its location in the video. In this way, different sounds of interest may be assigned to different stereo locations/positions, thus creating the illusion of a stereophonic soundscape.

Proposed embodiments may therefore provide hardware-based and/or software-based solutions that can process monophonic audio recordings and convert them into stereophonic audio (i.e., stereophonic soundscapes). Embodiments may thus enhance a listening experience and create a more immersive soundstage. Such proposed techniques may leverage digital signal processing algorithms to simulate the cues necessary for a stereo effect.

By way of summary, embodiments propose to analyze monophonic audio data of a video in combination with video data of the video to identify the source location of a sound. The sound may then be associated with the identified source location (and subsequently panned to the location in a stereophonic audio track). This general process may be thought of as sound source localization and panning.

A general outline of how a proposed embodiment may work is as follows:

Audio Analysis: The mono audio track is analyzed using various signal processing techniques to extract a sound of interest.

Sound Source Localization: Based on features identified in the video and features of the sound of interest, algorithms may identify the location of the sound source within the video. This can be achieved by comparing the features of the sound to variations of one or more features in the video, e.g., using machine learning algorithms to determine a sound source location.

Panning: Once the source location of the sound of interest is identified in the video, panning techniques may be applied to adjust the perceived direction and position of the sound of interest. This may involve manipulating the audio signals to create the illusion that the sound is coming from the identified location within a stereo or multichannel sound field. Panning techniques can include simple amplitude panning (adjusting the volume levels of left and right channels) or more advanced methods such as vector-based amplitude panning (VBAP) or ambisonics. These techniques aim to create a sense of movement and spatialization by appropriately distributing the sound across the stereo or multichannel sound system.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

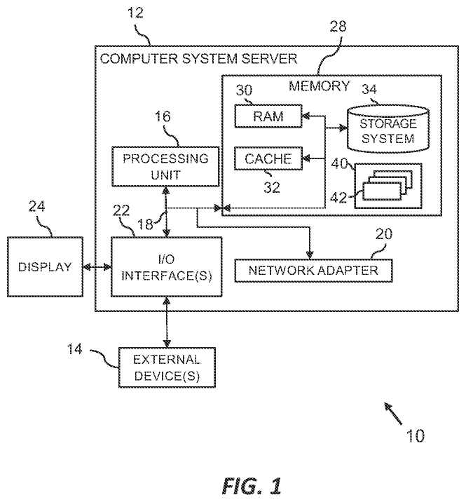

As shown in FIG. 1, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment.

Program modules 42 generally carry out the functions and/or methodologies of embodiments of the invention as described herein. For example, some or all of the functions of a DHCP client (not shown) can be implemented as one or more of the program modules 42. Additionally, the DHCP client may be implemented as a separate dedicated processors or a single or several processors to provide the functionality described herein. In embodiments, the DHCP client performs one or more of the processes described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to microcode, device drivers, redundant processing units, external disk drive arrays, RAID (redundant array of inexpensive disks or redundant array of independent disks) systems, tape drives, and data archival storage systems, etc.

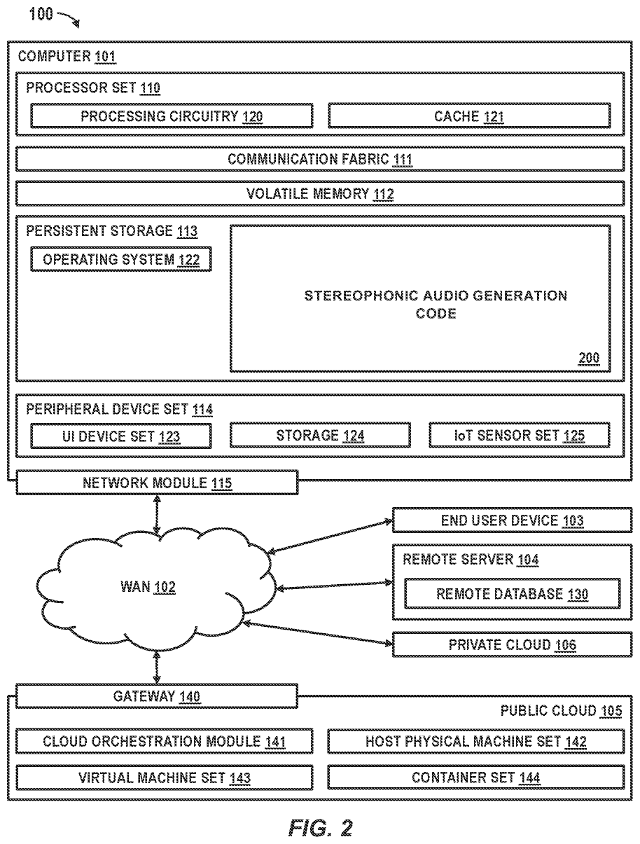

Referring now to FIG. 2, an illustrative computing environment 100 is depicted. A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

Computing environment 100 contains an example of an environment for the execution of at least some of the computer code involved in performing the inventive methods, such as a proposed method for defining a performance goal for a system application (i.e., stereophonic audio generation code) 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

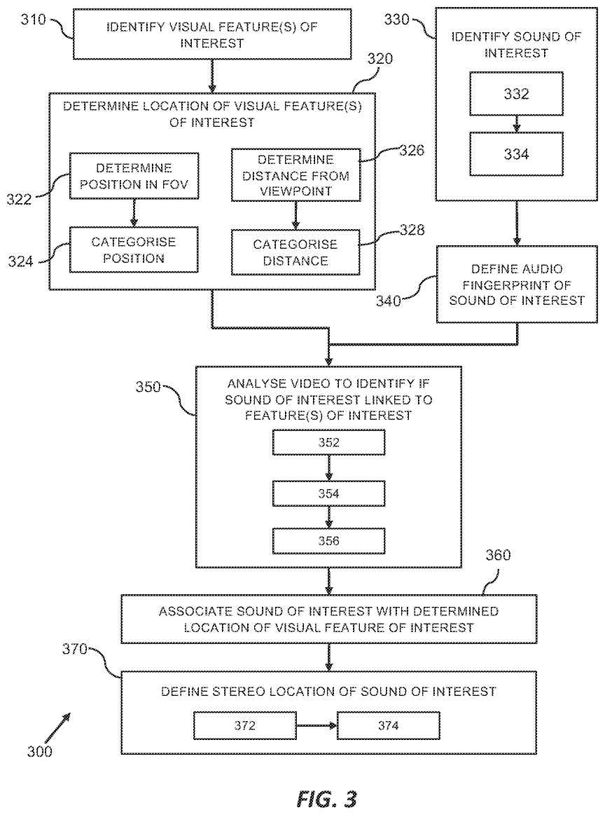

Referring now to FIG. 3, a flow diagram of a computer-implemented method 300 for generating stereophonic audio for a video having a monophonic audio track is shown, according to a purely exemplary embodiment. Here, the video is a recording of a human participant of a video conferencing call captured using a USB-powered webcam. The webcam has a single microphone integrated in its housing to capture monophonic audio to accompany the captured video of the participant.

The method 300 begins with the step 310. Step 310 includes processing the video with a feature recognition algorithm to identify a visual feature of interest. In this example, the visual feature of interest includes a representation of at least the head of a human participant of the video conferencing call. The feature recognition algorithm thus includes a head and/or face detection algorithm that is configured to detect and identify the presence of the head and/or face of a living body within the video.

The method then proceeds to step 320 in which, for the detected visual feature of interest (i.e., head of the participant), the spatial location of the visual feature of interest in the video is determined. In this exemplary embodiment, the spatial location of the visual feature of interest describes both: (i) a lateral position of the visual feature in the lateral axis of the field of view of the video (i.e., left to right position of the head of the participant within the captured video); and (ii) a distance of the visual feature from the viewpoint of the video (i.e., estimated distance of the head of the participant from the USB webcam).

Step 320 includes the following two sub-steps relating to the lateral position (i.e., steps 322 and 324) and the following two sub-steps relating to the distance (i.e., steps 326 and 328):
Step 322—analyze the video to determine a position of the visual feature of interest (i.e., head of the participant) in the field of view of the video; and
Step 324—based on the determined position of the visual feature of interest (i.e., head of the participant), categorize the lateral position of the visual feature of interest into one of a set of lateral position categories, namely left, right or center.

Step 326: analyze the video to determine a distance of the visual feature of interest (i.e., head of the participant) from the viewpoint of the video (i.e., location of the webcam); and

Step 328: based on the determined distance of the visual feature of interest, categorize the distance of the visual feature of interest (i.e., head of the participant) into one of a set of distance categories, namely near, middle, or far.

The method also includes steps 330 and 340 relating to determining an audio fingerprint of a sound of interest in the monophonic audio of the video.

Here, step 330 includes identifying in the monophonic audio track of the video, a sound of interest. More specifically, in this exemplary embodiment, step 330 includes two sub-steps 332 and 334:
Step 332—process the mono audio track with a voice recognition algorithm to detect one or more spoken words of interest (i.e., spoken dialogue detection); and Step 334—identify the detected one or more spoken words of interest as a sound of interest.

Step 340 includes determining an audio fingerprint for the sound of interest. Here, the audio fingerprint for the sound of interest describes a variation in an audio parameter value of the sound of interest, e.g., temporal variation in frequency, amplitude, wave form and/or duration.

After completion of steps 310-340, the method proceeds to step 350 of analyzing the video based on the sound of interest and its determined audio fingerprint to identify if the sound of interest is linked to any of the one or more visual features of interest. More specifically, step 350 of analyzing the video based on the sound of interest and its determined audio fingerprint includes three sub-steps 352, 354 and 356:
Step 352—identify a portion of the video associated with the mono audio track comprising the sound of interest sound of interest, i.e., identify the section of video associated with the sound of interest within the monophonic audio track;
Step 354—analyze the identified portion of the video to detect a causal relationship between the audio fingerprint of the sound of interest and a variation in the visual feature of interest; and
Step 356—responsive to detecting a causal relationship between the audio fingerprint of the sound of interest and a variation in a first visual feature of interest, identify that the sound of interest is linked to the visual feature of interest.

Responsive to identifying the sound of interest is linked to a visual feature of interest, the method proceeds to step 360. In step 360, the sound of interest is associated with the determined spatial location of the visual feature of interest in the video.

Finally, step 370 includes defining the stereo location of the sound of interest within stereoscopic audio for the video based on its associated spatial location in the video. Here, step 370 of defining the stereo location of the sound of interest within stereoscopic audio for the video includes: step 372—for generating metadata describing the spatial location associated with the sound of interest; and step 374—for associating the generated metadata with the sound of interest.

Although the exemplary method of FIG. 3 has been detailed in relation to the associating of a sound of interest with a position of a human participant in a videoconferencing call, embodiments need not be restricted to a feature of interest being a human (or part of a living body). For instance, in alternative embodiments, a feature of interest may be an object, item of equipment, apparatus or any other item, article, element or feature that may be a source of sound in a video.

Similarly, other steps of the method detailed above may be implemented differently in alternative embodiments. For instance, the step 370 of defining the stereo location of the sound of interest within stereoscopic audio for the video may not generate and associate metadata. Instead, the step 370 may include panning the sound of interest within stereoscopic audio for the video according to its associated spatial location in the video. By panning (e.g., defining its amplitude in each of the two stereo channels) the sound of interest, its position in the stereoscopic audio may thus be defined.

From the above description, it will be appreciated that the exemplary method of FIG. 3 may be employed to convert a sound of interest within monophonic audio of a video into a sound of interest stereophonic audio for the video. Also, the method may be repeatedly executed for more sounds of interest in the monophonic audio and/or to continually update the location of visual features of interest in the video. In this way, embodiments may support conversion of monophonic video to stereophonic video.

Thus, there are proposed one or more concepts for automatically dividing an input monophonic audio stream of a video into stereophonic channels, thus enabling the generation of stereo sound from a mono input. The mechanism proposed for doing this is based on analyzing the video input from the stream. Using image/feature recognition techniques, a source of a sound in monophonic audio stream may be identified in the video stream. The position/location of the identified source in the video stream may then be used to define the stereo position of the sound. That is, after matching a visual feature in the video stream with a sound in the mono audio (e.g., using characteristics or an audio fingerprint of the sound), the location of the sound's source may be identified and used to inform the stereo channel to which the sound should be panned.

For example, if two individuals are in the field of view of video, proposed embodiments may identify who is speaking and then pan that person's dialogue to the channel which matches their location in the video screen (e.g., panned to the right channel if they are on the right side of the field of view of the video).

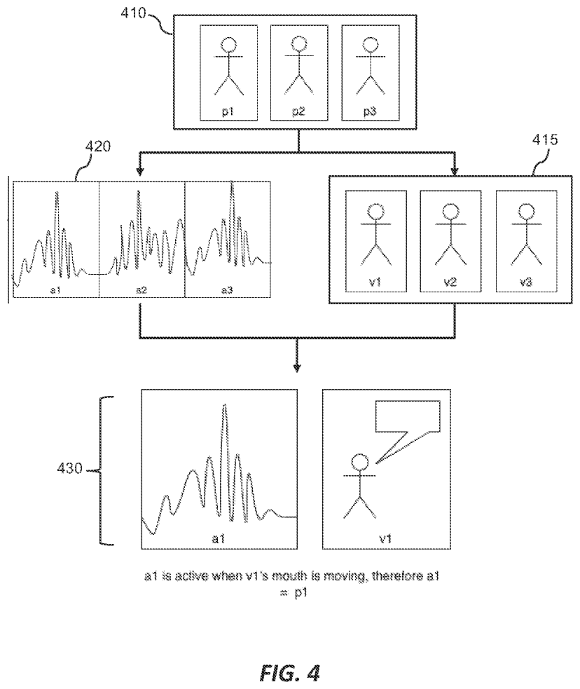

Purely by way of further description, a simplified implementation of an embodiment will now be described with reference to FIG. 4. FIG. 4 depicts a process of generating stereophonic audio for a video having a monophonic audio track according to a proposed embodiment.

In this example, a video of a conversation involving three participants identified as participant one (p1); participant two (p2); and participant three (p3) is shown. The video includes a video stream 410 with a field of view in which the three participants, p1, p2 and p3 are visible (as depicted by the feature labelled ‘410’ in FIG. 4). The video also includes a monophonic audio track 420 having a single audio channel (as depicted by the feature labelled ‘420’ in FIG. 4). Thus, the Input=Audio Data+Visual Data

The Audio Data=a1, a2, a3, a4 . . . aX, where a=an audio section of interest (e.g., a sentence in a conversation).

The Visual Data=v1, v2 . . . vX, where v=a visual feature of interest (e.g., a person)

Sources of sound in the video may therefore include p1, p2 . . . pX, where p=a participant that produce sound and appears in the visual input (e.g., person).

The video stream 410 is processed with an image/feature recognition algorithm to match visual features with the participants and identify the location of the features. As depicted by the feature labelled ‘415’ in FIG. 4, this enables the identification of the three participants in the field of view of the video, wherein: v1→p1; v2→p2; and v3→p3.

In this example, there are three visual features of interest (v1, v2, v3) and three participants (p1, p2, p3) in the visual data. Through identification of the visual features of interest, the location of each of the participants within the video may be identified (and categorized) as follows: v1→p1→left; v2→p2→right; v3→p3→center.

In this way, it can be concluded that participant one (p1) is on the left of the field of view, participant two (p2) is on the right of the field of view, and participant three (p3) is in the middle of the field of view.

Turning to the audio, the monophonic audio track 420 is processed to identify audio sections (i.e., sounds) of interest (e.g., a sentence in a conversation). For each of the identified audio sections a1, a2 a3, an audio fingerprint is determined (an audio fingerprint describing a variation in an audio parameter value of the audio section, e.g., temporal amplitude variation). In this way, audio fingerprints f1, f2 . . . fx may be associated with the identified audio sections as follows: a1→f1; a2→f2; a3→f3; a4→f1 . . . .

By analyzing the video and audio fingerprints, an active speaker can then be identified (e.g., based on detected mouth movements in the visual input) and matched with the corresponding audio fingerprint. By way of example, this may result in the following matches between fingerprints and participants: f1→p1; f2→p2; f3→p3; f1→p1. Thus, in this example: participant one (p1) speaks in audio sections a1 and a4; participant two (p2) speaks in audio section a2; and participant three (p3) speaks in audio section a3. It can then be concluded that audio sections a1 and a4 come from the left (because participant one has been identified on the left), as depicted by element 430 in FIG. 4. Similarly, it can be concluded that audio section a2 comes from the right, and audio section a3 comes from the center.

The audio sections are then panned to the appropriate locations in stereophonic audio based on the preceding conclusions. That is, a1→left; a2→right; a3→center; and a4→left. The stereo channels may thus be defined/distributed as follows: Left=a1, a4; Right=a2; Centre=a3.

The method may be frequently repeated to check if the participants have changed location, and audio sections may be reassigned accordingly.

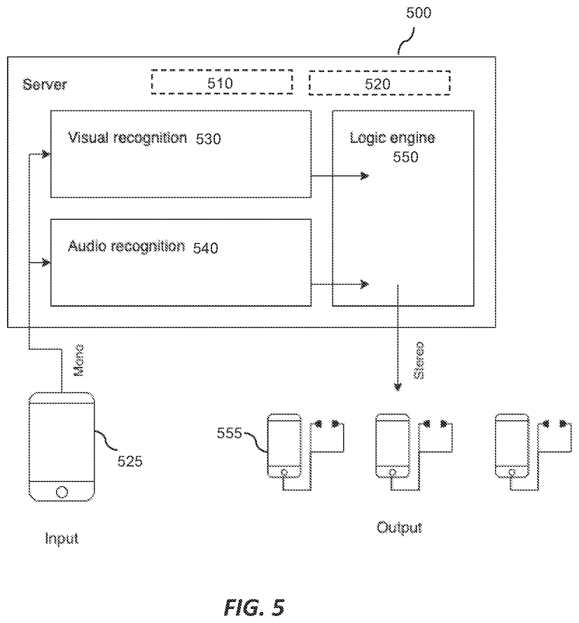

Referring now to FIG. 5, an exemplary system 500 for generating stereophonic audio for a video having a monophonic audio track is shown according to an embodiment of the present invention. Here, the system 500 is implemented in a cloud-based server.

The system 500 includes a processor arrangement 510 and a memory 520 including code stored thereon that, when executed, performs a method for generating stereophonic audio for a video having a monophonic audio track according to a proposed embodiment.

Specifically, the processor arrangement 510 and a memory 520 are configured to implement visual feature recognition 530 (to identify visual features of interest in the video), audio recognition 540 (to identify sounds of interest in the monophonic audio track and to determine their associated audio fingerprint), and a logic engine 550 (to link identified sounds of interest to identified visual features of interest and determine their stereo locations).

The exemplary system 500 of FIG. 5 is configured to receive, as in input, video with a monophonic audio track from a smartphone 525. Responsive to implementing the proposed method for generating stereophonic audio, the system 500 outputs the video with a stereophonic audio track from a smartphone to each of a plurality of smartphones 555.

From the above description, it will be understood that there are proposed concepts for generating stereophonic audio from monophonic audio of a video. These concepts may facilitate the automatic and real-time conversion of a mono video to a stereo video in a manner which is more accurate than existing approaches. For instance, proposed embodiments may not require bespoke hardware to solve the problem, but may instead by implemented using ubiquitous devices such as a smart phone or tablet computer.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

It should now be understood by those of skill in the art, in embodiments of the present invention, the proposed concepts provide numerous advantages over conventional stereophonic audio generation approaches. These advantages include, but are not limited to, reduction of resources associated with creating stereophonic audio for a video.

In still further advantages to a technical problem, the systems and processes described herein provide a computer-implemented method for efficient schema generation. In this case, a computer infrastructure, such as the computer system shown in FIGS. 1 and 2 can be provided and one or more systems for performing the processes of the invention can be obtained (e.g., created, purchased, used, modified, etc.) and deployed to the computer infrastructure. To this extent, the deployment of a system can include one or more of:
(i) installing program code on a computing device, such as computer system shown in FIG. 2, from a computer-readable medium;
(ii) adding one or more computing devices to the computer infrastructure and more specifically the cloud environment; and
(iii) incorporating and/or modifying one or more existing systems of the computer infrastructure to enable the computer infrastructure to perform the processes of the invention.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer implemented method for generating stereophonic audio for a video having a monophonic audio track, the method comprising:
processing the video using a feature recognition algorithm to identify one or more visual features of interest;
for each of the one or more visual features of interest, determining a spatial location of the visual feature of interest in the video;
identifying, in the monophonic audio track of the video, a sound of interest;
determining an audio fingerprint for the sound of interest;
analyzing the video based on the sound of interest and the determined audio fingerprint to identify if the sound of interest is linked to any of the one or more visual features of interest;
responsive to identifying the sound of interest is linked to a visual feature of interest, associating the sound of interest with the determined spatial location of the visual feature of interest in the video; and
defining a stereo location of the sound of interest within stereoscopic audio for the video based on the associated spatial location in the video.

2. The method of claim 1, wherein the visual feature of interest comprises a representation of at least part of a living body, and wherein the feature recognition algorithm comprises a body part detection algorithm configured to identify a presence of one or more parts of the living body within the video.

3. The method of claim 1, wherein the spatial location of the visual feature of interest describes a lateral position of the visual feature in a lateral axis of a field of view of the video, and wherein determining the spatial location of the visual feature of interest in the video comprises:
analyzing the video to determine a position of the visual feature of interest in the field of view of the video; and
based on the determined position of the visual feature of interest, categorizing the position of the visual feature of interest into one of a set of lateral position categories, wherein the set of lateral position categories comprises a left category; a center category; and a right category.

4. The method of claim 1, wherein the spatial location of the visual feature of interest further describes a distance of the visual feature of interest from a viewpoint of the video,
and wherein determining the spatial location of the visual feature of interest in the video comprises:
analyzing the video to determine a distance of the visual feature of interest from the viewpoint of the video; and
based on the determined distance of the visual feature of interest, categorizing the distance of the visual feature of interest into one of a set of distance categories,
wherein the set of distance categories comprises a near category; a middle category; and a far category.

5. The method of claim 1, wherein identifying the sound of interest in the monophonic audio track of the video comprises:
processing the monophonic audio track with a voice recognition algorithm to detect one or more spoken words of interest; and
identifying the detected one or more spoken words of interest as the sound of interest.

6. The method of claim 1, wherein the audio fingerprint for the sound of interest describes a variation in an audio parameter value of the sound of interest, and wherein the audio parameter comprises at least one of a frequency, an amplitude, a wave form or a duration.

7. The method of claim 1, wherein analyzing the video based on the sound of interest and the determined audio fingerprint comprises:
identifying a portion of the video associated with the monophonic audio track comprising the sound of interest;
analyzing the identified portion of the video associated with the mono audio track to detect a causal relationship between the audio fingerprint of the sound of interest and a variation in any of the one or more visual features of interest; and
responsive to detecting a causal relationship between the audio fingerprint of the sound of interest and a variation in a first visual feature of interest, identifying that the sound of interest is linked to the first visual feature of interest.

8. The method of claim 1, wherein defining the stereo location of the sound of interest within the stereoscopic audio for the video comprises:
generating metadata describing the spatial location associated with the sound of interest; and
associating the generated metadata with the sound of interest.

9. The method of claim 1, further comprising:
panning the sound of interest within the stereoscopic audio for the video based on the defined stereo location of the sound of interest.

10. A computer program product for generating stereophonic audio for a video having a monophonic audio track, comprising:
one or more computer readable storage media, and program instructions collectively stored on the one or more computer readable storage media, the program instructions comprising:
program instructions to process the video using a feature recognition algorithm to identify one or more visual features of interest;
for each of the one or more visual features of interest, program instructions to determine a spatial location of the visual feature of interest in the video;
program instructions to identify, in the monophonic audio track of the video, a sound of interest;
program instructions to determine an audio fingerprint for the sound of interest;
program instructions to analyze the video based on the sound of interest and the determined audio fingerprint to identify if the sound of interest is linked to any of the one or more visual features of interest;
responsive to identifying the sound of interest is linked to a visual feature of interest, program instructions to associate the sound of interest with the determined spatial location of the visual feature of interest in the video; and
program instructions to define a stereo location of the sound of interest within stereoscopic audio for the video based on the associated spatial location in the video.

11. The computer program product of claim 10, wherein the visual feature of interest comprises a representation of at least part of a living body, and wherein the feature recognition algorithm comprises a body part detection algorithm configured to identify a presence of one or more parts of the living body within the video.

12. A system comprising:
one or more processors; and
a memory comprising code stored thereon that, when executed, performs a method for generating stereophonic audio for a video having a monophonic audio track, the method comprising:
processing the video using a feature recognition algorithm to identify one or more visual features of interest;
for each of the one or more visual features of interest, determining a spatial location of the visual feature of interest in the video;
identifying, in the monophonic audio track of the video, a sound of interest;
determining an audio fingerprint for the sound of interest;
analyzing the video based on the sound of interest and the determined audio fingerprint to identify if the sound of interest is linked to any of the one or more visual features of interest;
responsive to identifying the sound of interest is linked to a visual feature of interest, associating the sound of interest with the determined spatial location of the visual feature of interest in the video; and
defining a stereo location of the sound of interest within stereoscopic audio for the video based on the associated spatial location in the video.

13. The system of claim 12, wherein the visual feature of interest comprises a representation of at least part of a living body, and wherein the feature recognition algorithm comprises a body part detection algorithm configured to identify a presence of one or more parts of the living body within the video.

14. The system of claim 12, wherein the spatial location of the visual feature of interest describes a lateral position of the visual feature in a lateral axis of a field of view of the video, and wherein determining the spatial location of the visual feature of interest in the video comprises:
analyzing the video to determine a position of the visual feature of interest in the field of view of the video; and
based on the determined position of the visual feature of interest, categorizing the position of the visual feature of interest into one of a set of lateral position categories, wherein the set of lateral position categories comprises a left category; a center category; and a right category.

15. The system of claim 14, wherein the spatial location of the visual feature of interest further describes a distance of the visual feature of interest from a viewpoint of the video,
and wherein determining the spatial location of the visual feature of interest in the video comprises:
analyzing the video to determine a distance of the visual feature of interest from the viewpoint of the video; and
based on the determined distance of the visual feature of interest, categorizing the distance of the visual feature of interest into one of a set of distance categories,
wherein the set of distance categories comprises a near category; a middle category; and a far category.

16. The system of claim 12, wherein identifying the sound of interest in the monophonic audio track of the video comprises:
processing the monophonic audio track with a voice recognition algorithm to detect one or more spoken words of interest; and
identifying the detected one or more spoken words of interest as the sound of interest.

17. The system of claim 12, wherein the audio fingerprint for the sound of interest describes a variation in an audio parameter value of the sound of interest, and wherein the audio parameter comprises at least one of a frequency, an amplitude, a wave form or a duration.

18. The system of claim 12, wherein analyzing the video based on the sound of interest and the determined audio fingerprint comprises:
identifying a portion of the video associated with the monophonic audio track comprising the sound of interest sound of interest;
analyzing the identified portion of the video associated with the monophonic audio track to detect a causal relationship between the audio fingerprint of the sound of interest and a variation in any of the one or more visual features of interest; and
responsive to detecting a causal relationship between the audio fingerprint of the sound of interest and a variation in a first visual feature of interest, identifying that the sound of interest is linked to the first visual feature of interest.

19. The system of claim 12, wherein defining the stereo location of the sound of interest within the stereoscopic audio for the video comprises:
generating metadata describing the spatial location associated with the sound of interest; and
associating the generated metadata with the sound of interest.

20. The system of claim 11, wherein the method further comprises:
panning the sound of interest within stereoscopic audio for the video based on the defined stereo location of the sound of interest.
